(19) United States
(12) Patent Application Publication
(10) Pub. No.: US 2019/0249587 A1
(43) Pub. Date: Aug. 15, 2019

(54) On-Board Diagnostics of an Exhaust Gas Catalytic Converter by S Parameter Measurement

(71) Applicant: CPT Group GmbH, Hannover (DE)

(72) Inventors: Ralf Moos, Bayreuth (DE); Willibald Reitmeier, Hemau (DE); Markus Dietrich, Regensburg (DE); Denny Schädlich, Neustadt (DE); Markus Hein, Bruck (DE); Katharina Burger, Regensburg (DE)

(73) Assignee: CPT Group GmbH, Hannover (DE)

(21) Appl. No.: 16/338,628

(22) PCT Filed: Sep. 18, 2017
(86) PCT No.: PCT/EP2017/073495

§ 371 Date: Apr. 1, 2019

(30) Foreign Application Priority Data
Oct. 10, 2016 (DE) 10 2016 219 646.4

(51) Int. Cl. F01N 11/00; F01N 3/20; F01N 13/00; B01D 53/94; G01N 22/00

(52) U.S. Cl. CPC F01N 11/007; F01N 3/208; F01N 13/008; B01D 53/9418; F01N 2900/1402; G01N 22/00; F01N 2550/02; F01N 2560/12; F01N 2560/14; B01D 53/9495

(57) ABSTRACT

Various embodiments include a catalyst measuring system for determining the aging state of a catalytic converter comprising: an SCR catalytic converter; and a high-frequency measuring arrangement including a processor, a first antenna, and a second antenna. The first antenna is located upstream of the SCR catalytic converter in the exhaust tract and the second antenna is located downstream of the catalytic converter. The processor instructs the antennas to selectively emit and receive electromagnetic signals and evaluates the transmitted and the received electromagnetic signals to compare them with predefined threshold values. The processor determines an aging state of the SCR catalytic converter based on the comparison.

### CROSS-REFERENCE TO RELATED APPLICATIONS

This application is a U.S. National Stage Application of International Application No. PCT/EP2017/073495 filed Sep. 18, 2017, which designates the United States of America, and claims priority to DE Application No. 10 2016 219 646.4 filed Oct. 10, 2016, the contents of which are hereby incorporated by reference in their entirety.

### TECHNICAL FIELD

The present disclosure relates to internal combustion engines. Various embodiments may include methods and systems including on-board diagnostics of an exhaust gas catalytic converter for an internal combustion engine.

### BACKGROUND

Passenger cars or trucks which are operated with internal combustion engines have become a permanent part of modern society. The automobile industry is aiming to develop vehicles which are distinguished by low emissions of pollutants and at the same time can be manufactured in a cost-effective manner. In particular, the development work is centred on nitrogen oxide reduction technologies. Therefore, new methods for exhaust gas purification are being developed in order to reduce the concentration of nitrogen oxide (NOx) in exhaust gases. One embodiment in this context is to use an ammonia SCR system. This system is advantageous, in particular, for lowering the NOx emissions of both trucks and passenger cars.

In some SCR systems, a urea solution is injected as a reducing agent into the exhaust system of the vehicle. This urea is vaporized in the exhaust system and is ultimately converted into gaseous ammonia (NH3). With this ammonia, the nitrogen oxides (NOx) are converted into nitrogen (N2) and water (H2O) in the catalytic converter. Ammonia must be firstly adsorbed, that is to say stored in the SCR catalytic converter. The conversion of NOx can depend to a great extent on the quantity of stored ammonia, in particular at low catalyst temperatures.

### SUMMARY

The teachings of the present disclosure describe systems and methods to monitor the operation of an SCR catalytic converter. For example, some embodiments include a catalyst measuring system (100) for on-board diagnostics and for determining the aging state of an SCR catalytic converter (110) for a vehicle, having: an SCR catalytic converter (110) for purifying the exhaust gas of a vehicle, and a high-frequency measuring arrangement (120) which has at least one first antenna (121) and one second antenna (122) for measuring the SCR catalytic converter (110). The first antenna (121) may be located upstream of the SCR catalytic converter and the second antenna (122) may be located downstream of the SCR catalytic converter. The high-frequency measuring arrangement (120) is designed to instruct the antennas (121, 122) to selectively emit and receive electromagnetic signals. The high-frequency measuring arrangement (120) is designed to evaluate the transmitted and the received electromagnetic signals and to compare them with predefined threshold values, in order to carry out on-board diagnostics of the catalyst measuring system (100) and to determine an aging state of the SCR catalytic converter (110).

In some embodiments, the high-frequency measuring arrangement (120) is designed to carry out at least four different measurements, wherein, for the first measurement, the first antenna (121) emits a signal and measures its reflection, wherein, for the second measurement, the second antenna (122) emits a signal and measures its reflection, wherein, for the third measurement, the first antenna (121) emits a signal and the second antenna (122) measures the emitted signal, and wherein, for the fourth measurement, the second antenna (122) emits a signal and the first antenna (121) measures the emitted signal.

In some embodiments, the predefined threshold values are the values of one of the last measurements, preferably of the last measurement.

In some embodiments, the high-frequency measuring arrangement (120) is designed to eliminate interference effects in the measurements by calculation while taking into account the comparisons of the received signals with the predefined threshold values.

In some embodiments, the high-frequency measuring arrangement (120) is designed to differentiate between interference/aging at the antennas (121, 122) and interference/aging at the SCR catalytic converter (110) while taking into account the comparisons of the received signals with the predefined threshold values.

In some embodiments, the high-frequency measuring arrangement (120) is designed to determine interference effects/aging at the antennas (121, 122) while taking into account the comparisons of the received signals with the predefined threshold values.

In some embodiments, the high-frequency measuring arrangement (120) is designed to assign the interference/aging to at least one antenna (121, 122) while taking into account the comparisons of the received signals with the predefined threshold values.

In some embodiments, the high-frequency measuring arrangement (120) is designed to re-calibrate the catalyst measuring system (100) by adapting the system parameters while taking into account the comparisons of the received signals with the predefined threshold value.

In some embodiments, the high-frequency measuring arrangement (120) is designed to carry out thermal regeneration of the SCR catalytic converter (110) while taking into account the comparisons of the received signals with the predefined threshold value.

As another example, some embodiments include a vehicle (500) having a catalyst measuring system (100) as claimed in one of the preceding claims, for on-board diagnostics and for determining the aging state of an SCR catalytic converter (110).

As another example, some embodiments include a method for on-board diagnostics and for determining the aging state of an SCR catalytic converter, having the following steps: acquiring (401) reference data; initialising (402) a measurement by operating the SCR catalytic converter at a predefined operating point; carrying out (403) four measurements, comprising the first antenna transmits and measures the reflection, the second antenna transmits and measures the reflection, the first antenna transmits and the second antenna measures the transmission, the second antenna transmits and the first antenna measures the transmission, comparing (404) the measured data with the reference data; carrying out (405) on-board diagnostics and determining the aging state of the SCR catalytic converter while taking into account the comparison of the measurement data with the reference data.

As another example, some embodiments include a program element which, when executed on a high-frequency measuring arrangement (120) of a catalyst measuring system (100), instructs the catalyst measuring system (100) to carry out the method as described above.

As another example, some embodiments include a computer-readable medium on which a program element as described above is stored.

### BRIEF DESCRIPTION OF THE DRAWINGS

Further features, advantages, and possible uses of the teachings herein emerge from the following description of the exemplary embodiments and figures. The figures are schematic and not true to scale. If the same reference signs are specified in the following description in various figures, they denote identical or similar elements.

FIG. 1 shows a schematic illustration of a catalyst measuring system incorporating teachings of the present disclosure;

FIG. 2 shows a schematic illustration of a motor with an exhaust system and the catalyst measuring system incorporating teachings of the present disclosure;

FIG. 3 shows a schematics illustration of an SCR catalytic converter incorporating teachings of the present disclosure and the measurement points for acquiring the S parameters;

FIG. 4 shows a flow diagram for a method for determining the aging of an SCR catalytic converter incorporating teachings of the present disclosure;

FIG. 5 shows a vehicle having an installed catalyst measuring system incorporating teachings of the present disclosure; and

FIG. 6 shows a flow diagram in which a method for on-board diagnostics of the SCR catalytic converter by measuring the S parameters is illustrated.

### DETAILED DESCRIPTION

Some embodiments of the teachings herein include a catalyst measuring system for on-board diagnostics and for determining the aging of an SCR catalytic converter for a vehicle. The catalyst measuring system may have the following components: an SCR catalytic converter for purifying the exhaust gases of a vehicle, a high-frequency measuring arrangement which has at least two antennas for measuring the resonance frequency of the SCR catalytic converter, wherein the first antenna may be located upstream of the SCR catalytic converter, and the second antenna may be located downstream of the SCR catalytic converter. The high-frequency measuring arrangement is designed to instruct both the antennas to selectively emit and receive electromagnetic signals. The high-frequency measuring arrangement is also designed to evaluate the transmitted and the received electromagnetic signals and to compare them with a predefined threshold value, in order to carry out on-board diagnostics and to determine an aging state.

The catalyst measuring system with high-frequency-assisted catalytic converter/filter diagnostics opens up many possibilities for controlling more precisely the exhaust gas catalytic converter and filter, as result of which the efficiency and therefore the NOx emissions of the SCR catalytic converter can be improved. However, the introduction of a plurality of antennas into the exhaust tract likewise give rise to new possibilities for interference effects. Diagnosing and compensating this reliably constitute an essential requirement of such high-frequency measuring arrangements and their use on the road, in particular with respect to long-term stability and the OBD requirements requirements (OBD: On-board diagnostics).

In some embodiments, the catalyst measuring system should be at a defined stable operating point at the start of the measuring process. A defined, stable operating point can be present when there is a constant temperature, when there is a constant volume flow of exhaust gas and/or when there is a constant EGR rate (exhaust gas recirculation rate). The ammonia dosing can be switched off for this. The catalyst measuring system can be operated without the dosing of ammonia until the high-frequency measuring arrangement detects a constant value for the ammonia loading. The SCR catalytic converter is then free of ammonia. The high-frequency measuring arrangement can input electromagnetic waves into the exhaust train via small coupling elements, e.g. antennas, and the reflections or the transmission of the emitted electromagnetic waves can be measured. The electromagnetic waves correlate with the state of loading of the SCR catalytic converter. The metallic catalytic converter housing constitutes an electrical cavity resonator.

In some embodiments, two or more simple antennas, for example, coaxial pin couplers which are introduced into catalytic converter housing, can serve as sensors. The di/electric properties of the SCR catalytic converter are determined by its ceramic honeycomb body, incl. the coating and the storage material and can be measured by means of the high-frequency measuring arrangement.

In exhaust gas catalytic converters, the changing of the resonance behaviour, for example the resonance frequency which is obtained from the reflection coefficients, can be used as a signal feature. Alternatively, the transmission can be used as a signal feature. If high-frequency electromagnetic waves are input into a cavity resonator by means of at least one of the antennas, a plurality of standing waves, which are referred to as modes, are formed in the said cavity resonator. Each mode has a separate oscillation pattern at the respective resonance frequency. These pronounced resonance points change their frequency and attenuation as a function of the state of loading of the SCR catalytic converter. It can therefore be possible to directly measure the ammonia loading of the SCR catalytic converter using this high-frequency measuring arrangement.

Aging can reflect both actual aging of the materials of the antenna and/or of the catalytic converter or also increasing contamination of the antenna and/or of the catalytic converter. Typical aging phenomena of an SCR catalytic converter are, for example, conversion of the storage centres, deactivation of the catalytically active layer, caused e.g. by oxidation or deposits of mainly metal oxides. Typical contamination phenomena are, for example, deposits of ammonia salts, soot or medium-chain to long-chain hydrocarbons.

For the detection of aging and the on-board diagnostics, the reflections and the transmissions can be measured by the at least two antennas at various operating points of the SCR catalytic converter. Therefore, at least four measurement variables can be acquired and compared. In some embodiments, the detection of the aging state of the catalytic converter and the on-board diagnostics of the catalyst measuring system may be based on the comparison of the individual resonance parameters for a system with at least two antennas, i.e. with at least four measurable resonance parameters. The resonance parameters can be divided into reflections and transmissions. The reflection and/or transmission parameters are also referred to as S parameters, wherein S11 denotes the reflection of the signals emitted by the first antenna, and the reflected signal is also received by the first antenna. The reflection of the signals which are emitted by the second antenna and can be received by the second antenna is referred to as S22. The signals which are emitted by the first antenna and which are received by the second antenna are referred to as S21, and the signals which are emitted by the second antenna and are received by the first antenna are referred to as S12. The two parameters S21 and S12 can be transmissions, i.e. the signals can pass through the SCR catalytic converter.

In some embodiments, the measurement takes place in known and/or defined operating states of the SCR catalytic converter, such as e.g. before the start in the case of a cold catalytic converter, when the operating temperature is reached after a start and at steady-state operating points or after regeneration of the SCR catalytic converter. In this context, the data from various operating points can also be used to acquire the state of the overall system.

In some embodiments, with separate diagnosis of contamination and/or aging of the individual antennas and of the aging phenomena of the SCR catalytic converter, it is possible to diagnose all the system-relevant individual components separately from one another. In some embodiments, the interference effects which occur as a result are compensated and the functionality of the catalyst measuring system is ensured. On the one hand, offset calibration and/or coupling adaptation by means of numerical compensation of the measured values is possible, and on the other hand it is possible to adapt the threshold values of the measured values (characteristic field values) as a function of the aging of the SCR catalytic converter.

In some embodiments, the measured values of the S parameters S11 and S22 can be used as a measure of the determination of aging. The behaviour of the SCR catalytic converter and therefore also the values of the S parameters change with progressive aging of the SCR catalytic converter and/or with decreasing activity of the SCR catalytic converter. Usually this is even a linear behaviour. The catalyst measuring system can be designed to carry out on-board diagnostics and detection of aging at specific, for example regular, intervals, and the aging state of the catalytic converter can therefore be monitored. If it is detected by the catalyst measuring system that a specific aging state has been exceeded, the user can be provided with an indication about replacing the catalytic converter. It is not necessary to provide an extra NOx sensor for detecting aging for the catalyst measuring system. The determination of aging is carried out exclusively by means of the high-frequency measuring arrangement with the at least two antennas.

In some embodiments, the S parameters can be acquired independently by the catalyst measuring system at constant operating points. The high-frequency measuring arrangement can also measure, inter alia, the maximum possible ammonia loading of the SCR catalytic converter. The catalyst measuring system can compare the current measured values with the reference values. If no deviations of the S parameters are detected, it can be assumed that there are no changes present in the catalyst measuring system. That is to say all the antennas are functionally capable and the SCR catalytic converter has not aged in comparison with the reference values.

If it is detected that the S parameters exhibit deviations in comparison with the reference parameters, the two S parameters S11 and S22 are compared with their respective reference values. If it becomes apparent here that the S parameters S11 and S22 do not exhibit any changes in comparison with the reference values, aging and/or contamination of the antennas can be ruled out, but aging of the SCR catalytic converter is very possible. If the S parameters S11 and/or S22 exhibit deviations, the disrupted antenna can be identified. Through knowledge of the disrupted antenna it is possible to correct the measured S parameters S12 and S21 by means of numerical methods, e.g. by means of the Newton method. After the correction of the S parameters, the S parameters S12 and S21 are compared with their respective reference values.

If no changes are apparent in the S parameters S12 and S21 in comparison with the reference values, disruption is present in the antennas and there is no aging of the SCR catalytic converter. If the S parameters S12 and S21 exhibit deviations in comparison with the reference values, disruption is present at the antennas and there is aging of the SCR catalytic converter. After on-board diagnostics have taken place, the catalyst measuring system can carry out measures e.g. thermal regeneration, in order to free the antennas of contamination, if contamination has been detected, and/or can trigger re-calibration of the catalyst measuring system. Furthermore, in the case of excessive aging the catalyst measuring system can indicate a replacement of the SCR catalytic converter.

Such high-frequency measuring arrangements are in principle also suitable for determining the oxygen loading of the three-way catalytic converters, lean NOx traps (LNT), diesel oxidation catalytic converters (DOC) or for the measurement of the soot loading of particle filters. Therefore, the system which is described above and below can also be applied in these catalytic converters/particle filters.

In some embodiments, the high-frequency measuring arrangement is designed to carry out four different measurements, wherein the first antenna emits a signal and measures its reflection, wherein the second antenna emits a signal and measures its reflection, wherein the first antenna emits a signal and the second antenna measures the emitted signal, and wherein the second antenna emits a signal and the first antenna measures the emitted signal. The use of at least two antennas results in at least four different measurement variables which can be considered. These measurement variables are also referred to as S parameters. Two of the S parameters S11 and S22 correspond to the reflections, and two of the S parameters S12 and S21 correspond to the transmissions. In the case of the reflections, electromagnetic signals can be emitted by one antenna and received again by the same antenna. The parameter S11 is the reflection of the first antenna, and the parameter S22 is the reflection of the second antenna. In the case of the transmission, the signals are emitted by one antenna and received by the respective other antenna, and the signals pass as it were through the SCR catalytic converter. S12 denotes that S parameter in the case which the measurement signal is emitted by the second antenna and received by the first antenna. The S parameter S21 denotes the signals which are emitted by the first antenna and are received by the second antenna.

In some embodiments, the predefined threshold values are one of the last measurements, preferably of the last measurement. The measured values which are acquired by the high-frequency measuring arrangement can be compared with predefined threshold values and/or reference values in order to the able to detect changes in the catalyst measuring system. In some embodiments, the values of the last measurement carried out, i.e. whether the SCR catalytic converter or one of the antennas has changed in comparison with the last measurement, are taken into account as possible threshold values. If it is detected that one of the antennas has changed in comparison with this measurement, the measured values can be corrected by an amount equal to the influence of the changed antenna. The aging state of the SCR catalytic converter can be determined with the corrected measured values. Therefore, a change in the system in comparison with the last measurement can be detected. Alternatively, the measured values of the catalyst measuring system in the new state can serve as reference values.

In some embodiments, the high-frequency measuring arrangement is designed to carry out diagnostics of the catalyst measuring system and to determine the aging state of the SCR catalytic converter while taking into account the measurement data. The aging can be calculated by the catalyst measuring system by comparing the measured S parameters with a predefined threshold value. It is possible to draw conclusions about the aging state of the SCR catalytic converter as a function of the comparison. The resonance frequencies of the SCR catalytic converter in the new state can serve as a possible threshold value. The aging of the SCR catalytic converter can therefore be determined with respect to the new state, or aging can be specified as a percentage. The resonance frequencies of the last valid measurement of the catalyst measuring system can be an alternative. The aging can therefore be tracked step-by-step. The catalyst measuring system can compare the measured resonance frequencies with the stored resonance frequencies and draw conclusions about the aging state of the SCR catalytic converter from this comparison. The older the SCR catalytic converter, the less ammonia can be stored, as a result of which the resonance frequency decreases.

In some embodiments, the high-frequency measuring arrangement is designed to detect interference effects in the measured data and eliminate them by calculation while taking into account the comparison of the received signals with the predefined threshold value. By obtaining the at least four measurement variables, each component of the catalyst measuring system can be diagnosed separately from one another. If it is detected that one of the antennas exhibits aging and/or contamination, the catalyst measuring system can correct the S parameters by an amount equal to this effect, using numerical methods. Therefore, an efficient diagnosis of the catalyst measuring system is possible even with partially disrupted antennas.

In some embodiments, the high-frequency measuring arrangement is designed to re-calibrate the catalyst measuring system while taking into account the diagnosis of the catalyst measuring system. If it is detected by the catalyst measuring system that the antennas have aging phenomena and/or contamination, the catalyst measuring system can trigger re-calibration of the system. Therefore, the catalyst measuring system can be placed in a new initial state for the next measurement.

In some embodiments, the high-frequency measuring arrangement is designed to carry out thermal regeneration of the SCR catalytic converter and of the components and measuring devices connected thereto, e.g. of the antennas while taking into account the diagnosis of the catalyst measuring system. If it is detected by the catalyst measuring system that the antennas have aging phenomena and/or contamination, the catalyst measuring system can trigger thermal regeneration of the system. As result, the antennas can be freed of contamination. Therefore, the catalyst measuring system can be placed in a new state for the next measurement, the antennas should be free of disruption.

In some embodiments, there is a vehicle having a catalyst measuring system for on-board diagnostics and for determining the aging state of an SCR catalytic converter. A vehicle can be equipped with the catalyst measuring system in order to decrease the NOx emissions of the vehicle. The catalyst measuring system is installed so that a flawless method of functioning of the SCR catalytic converter can be ensured. The catalyst measuring system can carry out on-board diagnostics, determine the aging state of the SCR catalytic converter and measure the stored quantity of ammonia in the SCR catalytic converter. If certain limiting values are exceeded or undershot, the catalyst measuring system can report them or, if appropriate, adapt the control of the ammonia dosing system. Furthermore, the catalyst measuring system can carry out thermal regeneration or re-calibration of the catalyst measuring system. The vehicle can be a gasoline vehicle, diesel vehicle, or biofuel or synthetic fuel or gas vehicle. The invention can also be used in hybrid vehicles with an internal combustion engine.

The vehicle is, for example, a motor vehicle, such as a car, a bus or a truck, or else also a rail vehicle, a ship, an aircraft such as a helicopter or an airplane.

In some embodiments, there is a method for on-board diagnostics and for determining the aging state of an SCR catalytic converter, having the following steps:
acquiring reference data.
initialising a measurement by operating the SCR catalytic converter at a predefined operating point.
carrying out four measurements, comprising
   the first antenna transmits and measures the reflection,
   the second antenna transmits and measures the reflection,
   the first antenna transmits and the second antenna measures the transmission,
   the second antenna transmits and the first antenna measures the transmission,
comparing the measured data with the reference data.
carrying out on-board diagnostics and determining the aging state of the SCR catalytic converter while taking into account the comparison of the measurement data with the reference data.

In some embodiments, the reference parameters for a later comparison can be generated at the start of the method. Either the behavior of an SCR catalytic converter in the new state or the last valid measurement can be used for this. Subsequently, the actual measurement of the SCR catalytic converter can be started, and a constant operating point of the SCR catalytic converter can be adopted for this. At this constant operating point, the temperature, the volume flow and the EGR rate should be kept constant. Subsequently, the four S parameters are measured. Measurement data from different operating points can also be used. The reflections of the first and/or second antenna are measured by the first and/or second antenna. The transmissions are also acquired by the two antennas.

In some embodiments, the first antenna emits an electromagnetic signal, and the second antenna measures the electromagnetic signal, and vice versa. The measured S parameters can then be compared with the reference parameters. Conclusions can be drawn about the state of the antennas of the high-frequency measuring arrangement and the aging state of the SCR catalytic converter from the comparison. An SCR catalytic converter can absorb less ammonia as it progressively ages, and in addition the SCR catalytic converter also reaches the absorbable quantity of ammonia more quickly. Therefore, both the absolute magnitude of the measurement parameters and the time profile can be used for the comparison. By means of the method, all the components of the catalyst measuring system can be analysed individually and checked for disruption. In addition, if appropriate the measurement data can be corrected by amounts equal to the interference influences using numerical methods. If destruction is diagnosed on one of the antennas, the method can provide for the catalyst measuring system to be re-calibrated or for thermal regeneration to be carried out. Furthermore, the determination of the aging of the SCR catalytic converter can be carried out without additional sensors. However, this does not mean further sensors cannot be installed, in order, for example, to ensure further functions.

The methods described herein permit the aging of the SCR catalytic converter to be determined, in particular with respect to its ammonia storage capacity, which has a decisive effect on its conversion rate and thus on its method of functioning. The determination of aging is carried out without the inclusion of further sensors in the exhaust system and under defined operating conditions. Through knowledge of the state of the system it is possible to adjust to an ideal storage quantity in the transient operating mode of the SCR catalytic converter. As a result, high conversion rates are ensured and unnecessary ammonia breakdowns are avoided. Therefore, the entire function of an SCR system can be basically improved, and operation can be carried out without ammonia slip. The consumption of ammonia is therefore reduced to the necessary minimum.

In some embodiments, there is a program element which, when executed by a high-frequency measuring arrangement of a catalyst measuring system, instructs the catalyst measuring system to carry out the method described.

In some embodiments, there is a computer-readable medium, on which a computer program is stored, which, when executed by a high-frequency measuring arrangement of a catalyst measuring system, instructs the catalyst measuring system to carry out the method described.

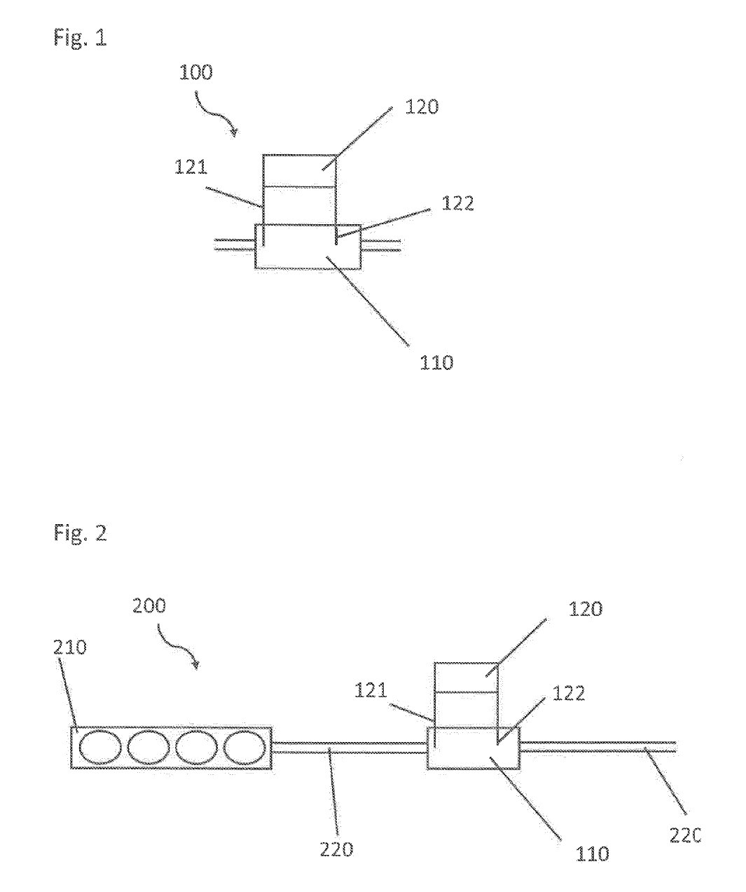

FIG. 1 shows a schematic illustration of a catalyst measuring system 100. The best possible conversion of the NOx takes into account the stored quantity of ammonia in the SCR catalytic converter 110. The ammonia loading can be calculated using models which are based on signals from the widest variety of sensors and actuators of the exhaust system. Furthermore, engine operating status data are input as an input variable into the models. Since the accuracy of the models is limited, and the parameters also change with time, an ammonia slip strategy is frequently applied. The problems arising here are, in particular, the inaccuracy of the model, since there is a fault chain of the individual components, e.g. in the engine controller, the temperature measurement, the sensor inaccuracies and the determination of the various actuator positions. In order to counter the problems described above of indirect measurement and of the models, the state of loading can be measured directly using a high-frequency measuring arrangement 120, also referred to as a microwave method, in order to determine the ammonia loading of an SCR catalytic converter 110.

The catalyst measuring system 100 has an SCR catalytic converter 110 and a high-frequency measuring arrangement 120 which has at least two antennas 121, 122. The antennas 121, 122 are located in the housing of the SCR catalytic converter 110, wherein one antenna 121 is installed upstream of the SCR catalytic converter 110, and the other antenna 122 is installed downstream of the SCR catalytic converter 110. The SCR catalytic converter 110 serves to remove noxious NOx emissions from the exhaust gas of the vehicle. Ammonia is additionally required to remove NOx emissions from the exhaust gas. Said ammonia is injected in liquid form into the exhaust system of the vehicle. The injected ammonia vaporizes and converts the NOx into nitrogen and water in the SCR catalytic converter 110. The two antennas 121, 122 emit electromagnetic waves and measure their reflections and/or transmissions. By means of these measured values it is possible to carry out on-board diagnostics of the catalyst measuring system 100 and to determine the aging state of the SCR catalytic converter 110.

By means of a comparison of the measured values it is also possible, inter alia, to detect interferences in the antennas 121, 122 and, if appropriate, measured values which are obtained from this disrupted antenna 121, 122 can be corrected. The high-frequency measuring arrangement 120 can measure the resonance frequency and the dielectric losses of the SCR catalytic converter 110. Both measured parameters change as a function of the quantity of the stored ammonia in the SCR catalytic converter 110. The high-frequency measuring arrangement 120 can compare the measured parameters with the reference parameters. The reference parameters can relate to the new state of the SCR catalytic converter 110 or to the last valid measurement by the catalyst measuring system 100. The aging state of the SCR catalytic converter 110 can be obtained by means of the comparison. The maximum stored quantity of ammonia decreases as the aging progresses.

FIG. 2 shows the catalyst measuring system 200 installed in an exhaust system 220 of a vehicle. The internal combustion engine 210 generates energy and exhaust gases when fuel is burnt. Inter alia, nitrogen oxides (NOx) also occur as a component of the exhaust gases. The exhaust gases are discharged into the environment by the exhaust system 220. So that not all the noxious exhaust gases can pass into the environment, exhaust gas purification systems, such as e.g. an SCR catalytic converter 110, are installed in the exhaust system 220. Furthermore, the catalyst measuring system 100 is installed in the exhaust system 220 in order to carry out the on-board diagnostics of the catalyst measuring system and to monitor the aging of the SCR catalytic converter 110. In addition, the control of the SCR catalytic converter 110 can be optimized.

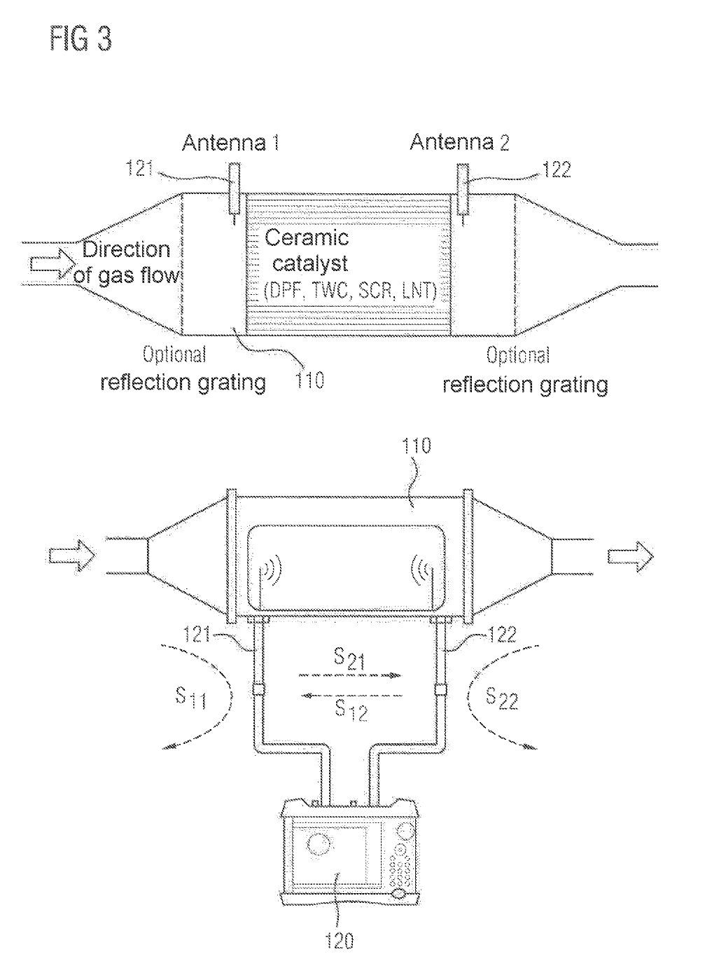

FIG. 3 shows a schematic illustration of a catalyst measuring system 100 incorporating teachings of the present disclosure. A first antenna 121 is installed upstream of or in the initial region of the SCR catalytic converter 110, and a second antenna 122 is installed downstream or in the end region of the SCR catalytic converter 110. In FIG. 3, the exhaust gases flow from left to right. The two antennas 121, 122 are connected to the high-frequency measuring arrangement 120. The high-frequency measuring arrangement 120 controls the two antennas 121, 122 and evaluates the data received by the antennas 121, 122. The first antenna 121 transmits the signals for the S parameters S11 and S21 and receives the signals for the S parameters S11 and S12. The second antenna transmits the signals for the S parameters S22 and S12 and receives the signals for the S parameters S22 and S21.

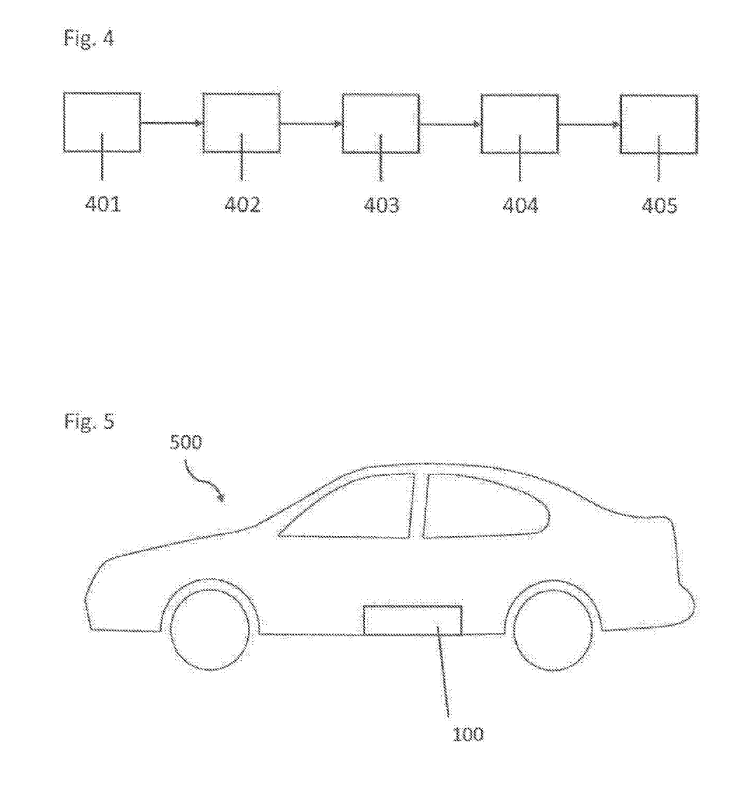

FIG. 4 shows a flow diagram for a method for on-board diagnostics and for determining the aging state of an SCR catalytic converter incorporating teachings of the present disclosure. In step 401, the reference parameters are determined for a later comparison. The initialization of the measurement is carried out in step 402. For this, the SCR catalytic converter is operated at a constant operating point. The measurement of the four S parameters is carried out in step 403. The comparison of the measured S parameters and of the reference parameters takes place in step 404. Finally, in step 405, the on-board diagnosis is produced, and the aging state of the SCR catalytic converter is determined, from the comparison of the measured S parameters and the reference parameters.

FIG. 5 shows a vehicle 500 with an SCR catalytic converter 110 and a catalyst measuring system 100. The catalyst measuring system 100 can detect the aging state of the SCR catalytic converter 110.

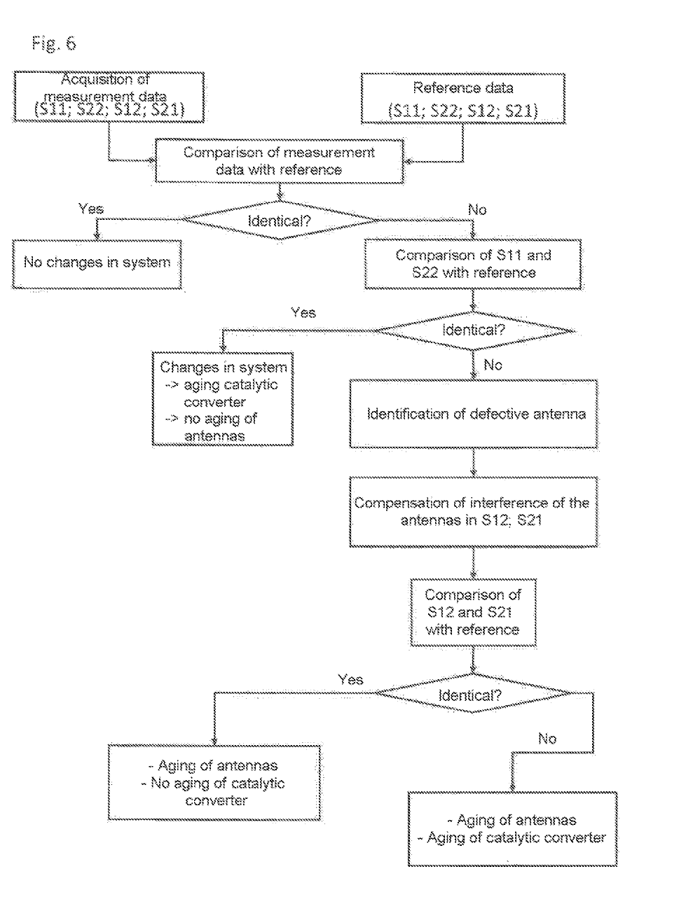

FIG. 6 shows a flow diagram which explains the method for on-board diagnostics and for determining the aging of an SCR catalytic converter. The catalyst measuring system carries out a measurement of the four resonance parameters S11, S22, S12, S21 (S parameters) in specific operating states of the engine/catalytic converter/overall system. By means of the comparison of the measured S parameters with the reference parameters, e.g. the values of the last diagnosis, it is possible to detect, when there is no change in the measured parameters, that both the antennas and the SCR catalytic converter are in the same state. If a change occurs, a more precise specification is made. By means of a comparison of the two reflection parameters S11 and S22 of the new measurement with the reference parameters it is possible to detect whether one antenna or both antennas has/have changed its/their behaviour, e.g. as a result of contamination or aging. If both antennas still behave in the same way, the previously detected change can be interpreted as a change in the catalyst material, e.g. caused by aging. If a change occurs in the behaviour of one antenna and/or both antennas, this interference can be eliminated by calculation by means of numerical methods. By comparing the compensated transmission parameters S21 and S12 with the reference parameters it is possible to detect a possible change in the catalyst material and evaluate it. All the integral components of the catalyst measuring system can therefore be diagnosed separately and precisely. The possible aging phenomena and/or contamination phenomena of the antenna can be compensated, and the catalyst measuring system can, if appropriate, be re-calibrated. Likewise, the initiation of a thermal regeneration is possible in order to free the antennas of contamination.

What is claimed is:

1. A catalyst measuring system for on-board diagnostics and determining the aging state of an SCR catalytic converter in the exhaust tract of a vehicle, the system comprising:
an SCR catalytic converter for purifying the exhaust gas of the vehicle; and
a high-frequency measuring arrangement including a processor, a first antenna, and a second antenna for measuring the SCR catalytic converter;
wherein the first antenna is located upstream of the SCR catalytic converter in the exhaust tract and the second antenna is located downstream of the SCR catalytic converter in the exhaust tract;
the processor instructs the antennas to selectively emit and receive electromagnetic signals; and
the processor evaluates the transmitted and the received electromagnetic signals to compare them with predefined threshold values; and
the processor determines an aging state of the SCR catalytic converter based on the comparison.

2. The catalyst measuring system as claimed in claim 1, wherein:
the high-frequency measuring arrangement carries out four different measurements;
the first measurement includes the first antenna emitting a first signal and measuring a reflection of the first signal;
the second measurement includes the second antenna emitting a second signal and measures a reflection of the second signal;
the third measurement includes the first antenna emitting a third signal and the second antenna measuring the third signal; and
the fourth measuring includes the second antenna emitting a fourth signal and the first antenna measuring the fourth signal.

3. The catalyst measuring system as claimed in claim 1, wherein the predefined threshold values are the values of a recent measurement.

4. The catalyst measuring system as claimed in claim 1, wherein the high-frequency measuring arrangement eliminates interference effects in the measurements by calculation while comparing the received signals with the predefined threshold values.

5. The catalyst measuring system as claimed in claim 1, wherein the high-frequency measuring arrangement differentiates between interference/aging at the antennas and interference/aging at the SCR catalytic converter while comparing the received signals with the predefined threshold values.

6. The catalyst measuring system as claimed in claim 1, wherein the high-frequency measuring arrangement determines interference effects/aging at the antennas while comparing the received signals with the predefined threshold values.

7. The catalyst measuring system as claimed in claim 5, wherein the high-frequency measuring arrangement assigns the interference/aging to at least one antenna while comparing the received signals with the predefined threshold values.

8. The catalyst measuring system as claimed in claim 1, wherein the high-frequency measuring arrangement re-calibrates the catalyst measuring system by adapting the system parameters while comparing the received signals with the predefined threshold value.

9. The catalyst measuring system as claimed in claim 1, wherein the high-frequency measuring arrangement initiates thermal regeneration of the SCR catalytic converter while comparing the received signals with the predefined threshold value.

10. A vehicle comprising:
an internal combustion engine;
an SCR catalytic converter in an exhaust tract of the internal combustion engine; and
a high-frequency measuring arrangement including a processor, a first antenna, and a second antenna for measuring the SCR catalytic converter;
wherein the first antenna is located upstream of the SCR catalytic converter in the exhaust tract and the second antenna is located downstream of the SCR catalytic converter in the exhaust tract;
the processor instructs the antennas to selectively emit and receive electromagnetic signals; and
the processor evaluates the transmitted and the received electromagnetic signals to compare them with predefined threshold values; and
the processor determines an aging state of the SCR catalytic converter based on the comparison.

11. A method for on-board diagnostics and for determining the aging state of an SCR catalytic converter in an exhaust tract of an internal combustion engine, the method comprising:
initialising a measurement by operating the SCR catalytic converter at a predefined operating point;
transmitting a first signal with a first antenna and measuring a reflection of the first signal with the first antenna;
transmitting a second signal with a second antenna and measuring a reflection of the second signal with the second antenna;
transmitting a third signal with the first antenna and measuring the third signal with the second antenna;
transmitting a fourth signal with the second antenna transmits and measuring the fourth signal with the first antenna;
comparing the measured data with reference data; and
determining the aging state of the SCR catalytic converter based on the comparison of the measurement data with the reference data.

12. (canceled)

13. A non-transitory computer-readable medium storing a set of instructions executable by a processor to determine the aging state of an SCR catalytic converter in an exhaust tract of an internal combustion engine, the instructions, when loaded and executed, causing the processor to:
initialize a measurement by operating the SCR catalytic converter at a predefined operating point;
transmit a first signal with a first antenna and measure a reflection of the first signal with the first antenna;
transmit a second signal with a second antenna and measure a reflection of the second signal with the second antenna;
transmit a third signal with the first antenna and measure the third signal with the second antenna;
transmit a fourth signal with the second antenna and measure the fourth signal with the first antenna;
compare the measured data with reference data; and
determine the aging state of the SCR catalytic converter based on the comparison of the measurement data with the reference data.
